(19) United States
(12) Patent Application Publication
(10) Pub. No.: US 2016/0161366 A1
(43) Pub. Date: Jun. 9, 2016

(54) QUAD OPTICAL TIME DOMAIN REFLECTOMETER (OTDR)

(71) Applicant: AFL Telecommunications LLC

(72) Inventors: Dennis FLORA, Penacook, NH (US); Scott PRESCOTT, Belmont, NH (US); Dale EDDY, Gilford, NH (US); Jianxun FANG, Concord, NH (US)

(73) Assignee: AFL Telecommunications LLC

(21) Appl. No.: 15/007,664

(22) Filed: Jan. 27, 2016

Related U.S. Application Data
(63) Continuation of application No. 14/143,865, filed on Dec. 30, 2013, now abandoned.
Application No. 14/143,865 is a continuation of application No. 13/123,136, filed on Apr. 7, 2011, now abandoned.
(60) Provisional application No. 61/266,799, filed on Dec. 4, 2009.

(51) Int. Cl. G01M 11/00

(52) U.S. Cl. CPC G01M 11/3154

(57) ABSTRACT

An optical device that includes a first laser source, a multimode coupler optically connected to the first laser source, a first test port optically connected to the multimode coupler, a second laser source, a singlemode coupler optically connected to the second laser source, a second test port optically connected to the singlemode coupler, a photodetector, and a multimode/singlemode combiner optically connected to the multimode coupler, singlemode coupler and photodetector.

### CROSS-REFERENCE TO RELATED APPLICATIONS

This is a continuation application of U.S. application Ser. No. 14/143,865, filed Dec. 30, 2013, which is a continuation of U.S. application Ser. No. 13/123,136 filed Apr. 7, 2011, which is a National Stage of PCT/US2010/059017 filed Dec. 6, 2010, which is based upon and claims the benefit of priority from U.S. Provisional Application No. 61/266,799, filed Dec. 4, 2009 in the United States Patent and Trademark Office, the disclosures of which are incorporated herein in their entirety by reference.

### BACKGROUND OF THE INVENTION

1. Field of the Invention

The invention relates to an optical device that can be used to verify optical fiber connectivity. More particularly, it relates to a quad optical time domain reflectometer (OTDR) that can test two wavelengths of single mode fiber and two wavelengths of multimode fiber.

2. Background

Testing regimens for fiber optic cables normally include a determination of two key measurables. The first measurable is a transmission loss, or other similar parameters, of each fiber optic cable. The second measurable is a verification of the connectivity of each fiber, i.e., verifying that each fiber terminates at an expected port at each end of the cable.

Various testing devices for determining these measurables are known in the related art, including an OTDR.

An OTDR generally is connected to a first end of a fiber to be tested, and transmits pulsed light signals along the fiber. Reflections and/or backscattering occur within the fiber due to discontinuities such as connectors, splices, bends and faults. The OTDR detects and analyzes these reflections and/or backscattering, and provides an OTDR trace that shows positions of discontinuities and an end-to-end loss in the fiber.

For small handheld OTDR instruments, space for the optical assemblies and related electronics is limited. Multimode and singlemode testing requires duplicate sets of lasers, optical couplers, photodetectors, and receiver electronics. Duplication of optical and electronic components requires space to ensure proper operation of the optical assemblies, in turn requiring a larger enclosure for the OTDR. The duplication of components and larger enclosure adds cost to the instrument and increases the over all size of the instrument.

Unlike singlemode couplers, optical back reflections from internal terminations of multimode couplers is always higher (in the low 40 dB range) because of the nature of multimode fiber. Such a high back reflection can affect the optical receiver ‘dead zone’, causing the instrument to be less precise in detecting events close to the instrument on multimode optical fiber.

The quad optical assembly as used in an OTDR test instrument dates back to the original concept as illustrated in FIG. 1, where two separate optical assemblies were required to give an OTDR test capabilities on both types of optical fiber. This topology was used in the Noyes M600 mini-OTDR, where each assembly was contained in its own modular housing. While this topology was simple to implement, it was expensive due to the need to have identical optical and electronic components in each housing, doubling the cost over that of a single optical fiber type OTDR and taking up twice as much space in the OTDR case.

To meet the need of reducing the cost of and the space required for a multimode/singlemode OTDR, an optical topology combining some of the common elements between multimode and singlemode to reduce component count as well as reduce the amount of electronic circuitry needed to interface with the optical assembly was created. One component that was duplicated using the original topology was the avalanche photodetector (APD). By reconfiguring the optical topology to allow the multimode and singlemode optical assemblies to share the same APD as seen in FIG. 2, the active optical component count was reduced, the requirement for two identical sets of receiver electronics connecting to the APD was reduced to a single set, and the physical amount of optical fiber was reduced as well. This optical topology was employed in the AFL-Noyes M100 OTDR and the AFL-Noyes M200 OTDR. Of note, the two multimode couplers in FIG. 2 are conventional 3 dB 1×2, 50:50 multimode couplers.

This optical topology is similar to the topology disclosed in U.S. Patent Publication No. 2009/0040509 A1. There are also similarities to U.S. Pat. No. 5,137,351, but the optical topology described in the '351 patent incorporates an active optical switch to change between multimode and singlemode fiber testing. Such a topology requires drive electronics and software to control the switch and adds considerable cost. The topology employed by AFL-Noyes OTDRs mentioned above is passive in nature and requires no such control circuitry or software to implement.

While the optical topology in FIG. 2 met the need for reducing optical and electronic component counts, there were performance compromises due to the mixed multimode/singlemode optical paths in regards to return path loss, mode-filling, and receiver (APD) saturation.

Return path loss through the 3 dB 1×2, 50:50 multimode coupler connected to the APD exceeds 3 dB for both multimode and singlemode return pulses.

Mode-filling, specifically on the laser pulse transmission path on multimode portion of the optical assembly and the return pulse path on the singlemode portion, needed to be addressed. In order to ensure the proper mode-filling in the multimode optical transmission path, lasers with an angular coupling offset were required. Lasers of this type are not readily available. On the singlemode receive path, the transition from singlemode fiber to multimode fiber causes mode propagation path variations, in turn causing the singlemode return pulses to illuminate only small portions of the active area of the avalanche photodetector (APD). This can create inconsistencies in the performance of the singlemode portion of the OTDR. While mode conditioning to reduce this problem by use of a series of different fiber types at the singlemode/multimode transition can be used, the added length of optical fiber required would take up too much of the limited space within the case of the OTDR.

Due to the nature of multimode couplers, specifically 1×2 couplers, the internal optical termination can generate a large reflection on the order of 40 dB. The multimode coupler in the transmission path generates just such a reflection, which in turn coupled back to the APD, temporarily overloading it and ‘blinding’ the receiver, adversely affecting the OTDR dead zone. Therefore, a new means of addressing the path loss, mode filling, and APD saturation was needed.

### BRIEF SUMMARY OF THE INVENTION

An object of the invention is to provide an apparatus and method for verifying optical fiber connectivity using an OTDR test receiver with which the transmission characteristics of a fiber are determined.

Exemplary embodiments of the invention are shown in FIGS. 3 through 5. By utilizing a combined hybrid optical assembly it is possible to make use of a single photodetector and receiver for both multimode and singlemode while reducing the internal back reflections on the multimode portion of the optical assembly. Rather than two separate optical assemblies and two separate receivers, the combined optical assembly reduces the number and costs of optical and electronic components required, while at the same time reducing the physical space requirements. Also, multimode optical back reflections are minimized by using an external low back reflection termination. To ensure proper filling of the core of the multimode fiber by the lasers used, an offset optical splice is incorporated into the multimode side of the optical assembly for mode conditioning.

One of the features of the combined assembly is a hybrid multimode/singlemode optical combiner that allows for the return signals to use a single photodetector and receiver while greatly reducing the optical loss inherent in optical couplers. This allows retention of optical dynamic range without the need to increase laser output power to compensate for the loss.

Reduction of the back reflection caused by the internal termination of the multimode coupler used to connect the multimode lasers and photodetector to the external test port is accomplished by making use of a second output leg from the coupler equal in length to the primary output leg (test port). This additional output leg is terminated with an angled ceramic ferrule which reduces the back reflection of the outgoing laser pulse. The angled ferrule is used with either an encapsulating optical grade epoxy or an index matching gel and opaque cap. Both methods provide a greater reduction of back reflection by up to four orders of magnitude from a standard non-angled termination.

A first embodiment of the invention is an optical device that includes a first laser source, a multimode coupler optically connected to the first laser source, a first test port optically connected to the multimode coupler, a second laser source, a singlemode coupler optically connected to the second laser source, a second test port optically connected to the singlemode coupler, a photodetector, and a multimode/singlemode combiner optically connected to the multimode coupler, singlemode coupler and photodetector.

A second embodiment of the invention is an optical device that includes a multimode laser source, a 2×2, 50:50 split ratio multimode coupler optically connected to the multimode laser source, a multimode test port optically connected to the multimode coupler, a singlemode laser source, a 1×2, 50:50 split ratio singlemode coupler optically connected to the singlemode laser source, a singlemode test port optically connected to the singlemode coupler, a photodetector, and a multimode/singlemode combiner optically connected to the multimode coupler, singlemode coupler and photodetector.

### BRIEF DESCRIPTION OF THE DRAWINGS

The above and other objects, features and advantages of the invention will become more apparent by describing in detail exemplary embodiments thereof with reference to the attached drawings in which:

FIG. 1 shows a topology of a conventional quad assembly.

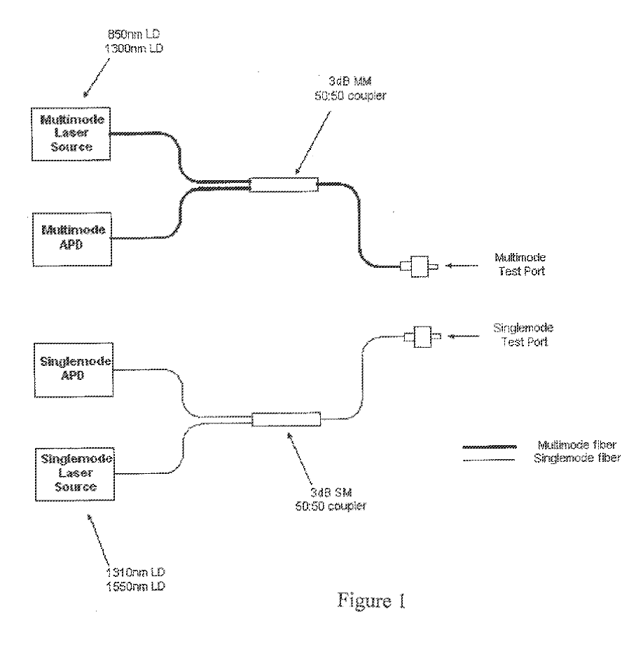

FIG. 2 shows a topology of another conventional quad assembly.

FIG. 3 shows one embodiment of the invention.

FIG. 4 shows another embodiment of a laser system that can be used in the invention.

FIG. 5 shows details of one embodiment of a multimode/singlemode hybrid combiner that can be used in the invention.

### DETAILED DESCRIPTION OF EXEMPLARY EMBODIMENTS OF THE INVENTION

Exemplary embodiments of the invention will now be described below by reference to the attached Figures. The described exemplary embodiments are intended to assist the understanding of the invention, and are not intended to limit the scope of the invention in any way. For example, although the invention is described in the context of an OTDR, the invention is not limited to use as in an OTDR, but can be applied in any fiber optic application where improved return signal and hence signal to noise ratio are a benefit.

To address some of the problems described in the background, such as the mode-filling issue on the multimode transmission path without the need for special lasers, a new design with a radial offset splice between the lasers and the multimode coupler was employed. The offset causes a change in the mode propagation through the multimode fiber, ‘creating’ more high order modes to fill the core of the fiber.

Mode-filling in the singlemode return path needed to be handled and the aforementioned mode conditioner was not seen as a viable solution due to the amount of fiber needed. Instead, a hybrid multimode/singlemode combiner was developed as a means to properly combine the return pulses from the multimode and singlemode test ports. The combiner uses a multimode and a singlemode fiber input with a multimode fiber output, which in turn couples the return pulses to the APD. The singlemode return pulses propagate through the multimode fiber to the APD in a more predicable manner, reducing the variability seen when using a multimode coupler.

The combiner also dealt with another problem—return path loss. A conventional 1×2, 50:50 ratio multimode coupler will exhibit a signal loss of 3 dB (50%) or greater. On the other hand, due to the hybrid nature of the combiner used in the invention, path loss between the multimode or singlemode inputs and the multimode output is less than 2 dB and typically ˜1 dB (˜20%), or lower. With the loss across the couplers connected to each test port, the total return path loss is reduced from ˜6 dB to ˜4 dB. This is a significant improvement in performance.

The high reflection seen from the internal termination stub of a multimode 1×2, 50:50 coupler causing saturation of the APD was addressed by using a multimode 2×2, 50:50 coupler. The internal termination stub was eliminated by the second output leg. By making this second leg exactly the same length as the primary output leg (test Port connection), the reflection has been moved from the coupler to the end of the second leg. To reduce the amplitude of that reflection, the leg is terminated with a low back-reflection termination which can take the form of an angled cleave or angled physical contact (APC) ferrule with a angle equal to or greater than 8° (12° is preferred), or some other low back-reflection termination device or method. With this method, the sum of the two equidistant reflections is not much greater than the amplitude of the primary reflection alone. This reduces the reflection seen by the APD, in turn reducing saturation, a lengthy overload condition, and restoring the instrument dead zone.

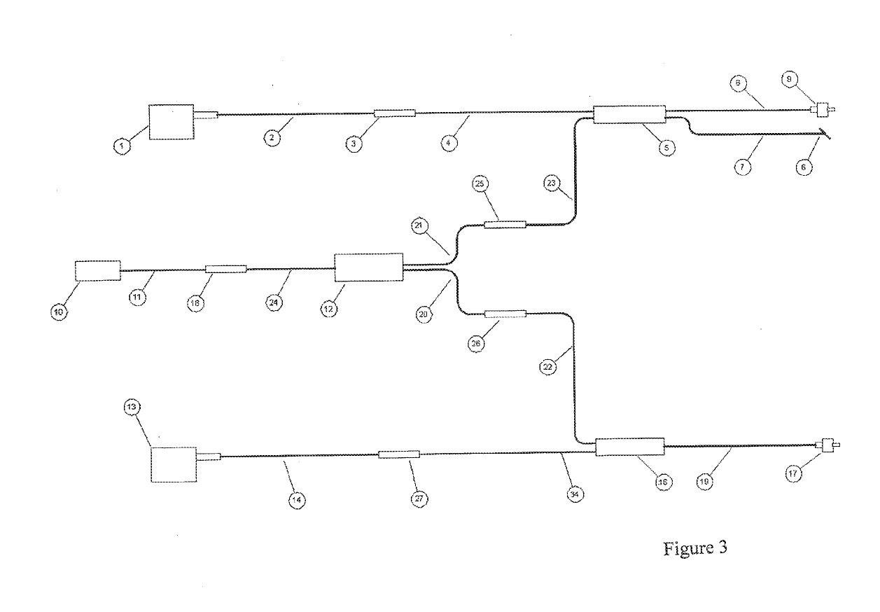

FIG. 3 is a schematic of the optical topology of one embodiment of the invention. The invention includes both separate and shared components and optical paths for multimode and singlemode operations. The multimode fiber as shown has a core diameter of 62.5 μm, but other multimode core diameter fibers can be used as well, such as 50 μm. The singlemode fiber as shown has a core diameter of 9 μm, but other singlemode core diameter fibers can be used as well, such as 5 μm. Multimode pulse laser system 1 includes two lasers to generate the optical pulses on the required wavelengths, nominally 850 nm and 1300 nm (though the invention is not limited to those wavelengths), which in turn are coupled via multimode optical fiber 2, optical splice 3, and multimode optical fiber 4 to one of the two ports on one side of 2×2, 50:50 split ratio, 850/1300 nm multimode coupler 5. Optical splice 3 incorporates a 10 μm radial offset to create a mode conditioner for the laser pulses generated by multimode pulse laser system 1. In this particular embodiment, the minimum length for fibers 2 and 4 to ensure proper mode conditioning is 39 inches (˜1 meter). The other side of coupler 5 connects to multimode fiber pigtail assemblies 8 and 9 and 7 and 6. In this particular embodiment, the lengths of fibers 7 and 8 are identical and are a minimum of 39 inches in length. Optical connector 9 is the multimode test port allowing connection to external multimode fiber spans under test. Optical termination 6 is a low back-reflection termination.

Singlemode pulse laser system 13 includes two lasers to generate the required wavelengths, nominally 1310 nm and 1550 nm (though the invention is not limited to those wavelengths), which in turn are coupled via singlemode fiber 14, optical splice 27, and singlemode optical fiber 34 to one of two ports on the two-port side of 1×2, 50:50 split ratio, 1270 nm-1650 nm wideband singlemode coupler 16. The other side of coupler 16 connects to singlemode fiber pigtail assembly 19 and 17. Optical connector 17 is the singlemode test port allowing connection to the external singlemode fiber spans under test. In this particular embodiment, the length of optical fiber 19 is similar to that of optical fibers 7 and 8.

Avalanche Photodetector (APD) 10 is the means by which return light pulses from the fibers under test are detected and connects via multimode optical fiber 11, optical splice 18, and multimode fiber 24 to the output port of 1×2 multimode/singlemode hybrid combiner 12. Combiner 12 singlemode input port connects via singlemode fiber 20, optical splice 26, and singlemode fiber 22 to the second port on the two-port side of 1×2, 50:50 split ratio, 1270 nm-1650 nm wideband singlemode coupler 16, allowing the return light pulses from the singlemode fiber span under test to be coupled to APD 10. APD 10, fibers 11, 14, 19, 20, 22, 24, 34, splices 18, 26, 27, coupler 16, combiner 12, connector 17, and laser system 13 comprise the singlemode optical path. Combiner 12 multimode input port connects via multimode fiber 21, optical splice 25, and multimode fiber 23 to the second port of the two ports on one side of 2×2, 50:50 split ratio, 850/1300 nm multimode coupler 5, allowing the return light pulses from the multimode fiber span under test to be coupled to APD 10. APD 10, fibers 2, 4, 7, 8, 11, 21, 23, 24, splices 3, 18, 25, coupler 5, combiner 12, connector 9, termination 6, and laser system 1 comprise the multimode optical path.

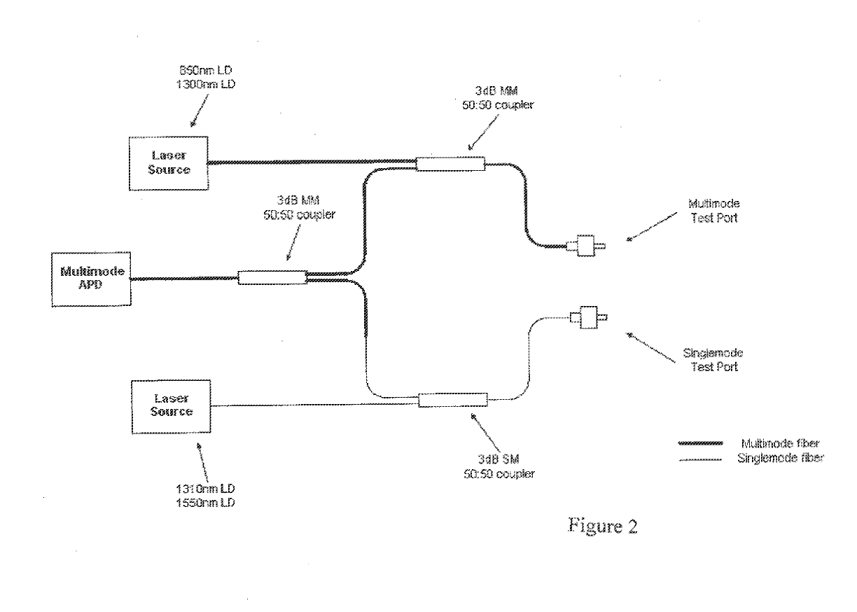

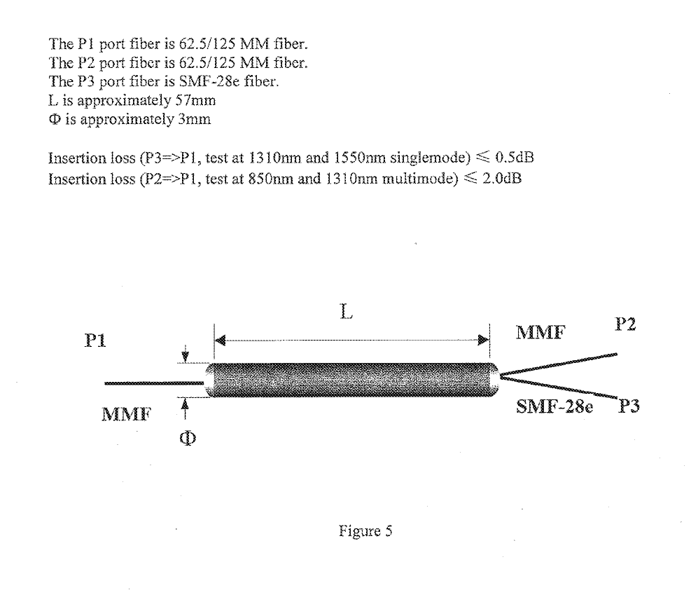

A 1×2 multimode/singlemode hybrid combiner 12 is used to combine the multimode and singlemode return light pulses while providing minimal optical loss, improving the dynamic range of an OTDR employing the invention. Combiner 12 has low loss (less than 2 dB and preferably 1 dB or lower) compared to the multimode 1×2 coupler (˜3 dB) as seen in FIG. 2 or as used in U.S. Patent Publication No. 2009/0040509 A1, and does not require mode conditioning as in the aforementioned publication. The combiner function can be accomplished through use of a hybrid fusion coupler incorporating singlemode and multimode optical fiber (the method employed in this embodiment), a planar light-wave circuit (PLC), a photonic integrated circuit (PIC), or other hybrid or discrete optical devices. Additional details about this particular embodiment of combiner 12 is shown in FIG. 5.

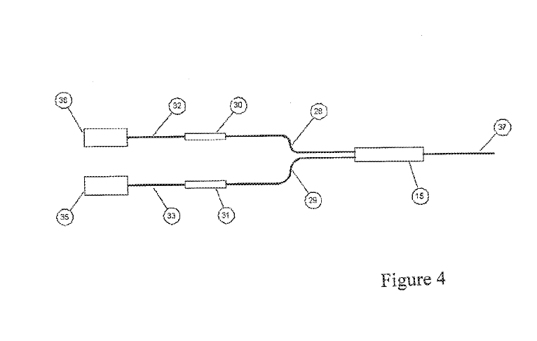

As shown in FIG. 4, laser systems 1 and/or 13 may also be configured using discrete lasers and couplers. For example, multimode laser system 1 could be replaced a combination of laser 36, for example 850 nm, connected via multimode optical fiber 32, optical splice 30, multimode optical fiber 28, to the 850 nm port of 1×2, wavelength-division multiplexing multimode coupler 15; and laser 35, for example 1300 nm, connected via multimode optical fiber 33, optical splice 31, and multimode optical fiber 29 to the 1300 nm port of 1×2, wavelength-division multiplexing coupler 15. The single port of coupler 15 connects via multimode optical fiber 37, optical splice 3, and multimode optical fiber 4 to one of the two ports on one side of 2×2, 50:50 split ratio, 850/1300 nm wideband multimode coupler 5. Optical splice 3 incorporates a radial offset to create a mode conditioner for the laser pulses generated by the multimode pulse laser system described herein.

Singlemode fiber coupled laser system 13 could be replaced by a combination of laser 36, for example 1310 nm, connected via singlemode optical fiber 32, optical splice 30, singlemode optical fiber 28, to the 1310 nm port of 1×2, wavelength-division multiplexing singlemode coupler 15; and laser 35, for example 1550 nm, connected via singlemode optical fiber 33, optical splice 31, and singlemode optical fiber 29 to the 1550 nm port of 1×2, wavelength-division multiplexing singlemode coupler 15. The single port of coupler 15 connects via singlemode optical fiber 37, optical splice 27, and singlemode optical fiber 34 to one of two ports on the two-port side of 1×2, 50:50 split ratio, 1270 nm-1650 nm wideband singlemode coupler 16.

In addition, the laser systems 1 and 13 could use more than two lasers.

On the multimode side of the optical schematic note was made of optical termination 6, a low back-reflection termination. The termination at the end of multimode optical fiber 7 is used as a means to eliminate internal termination reflections normally seen in a typical 1×2, 50:50 multimode coupler. By using 2×2 multimode coupler 5 with termination 6 the internal termination reflections are removed by shifting them to the same location as optical connector 9, but with greatly reduced amplitude. This prevents APD 10 from saturating and minimizes OTDR event and attenuation dead zone at the multimode test port. A 2×2 coupler is not required on the singlemode side due to the inherently low internal termination reflections of a singlemode 1×2 coupler.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

1. An optical device comprising:
a first laser source;
a multimode coupler optically connected to the first laser source;
a first test port optically connected to the multimode coupler;
a second laser source;
a singlemode coupler optically connected to the second laser source;
a second test port optically connected to the singlemode coupler;
a photodetector;
and a multimode/singlemode combiner optically connected to the multimode coupler, singlemode coupler and photodetector.

2. The optical device of claim 1, wherein:
the first laser source is a multimode fiber coupled laser source;
the first test port is a multimode test port;
the second laser source is a singlemode fiber coupled laser source;
and the second test port is a singlemode test port.

3. The optical device of claim 1, wherein:
the multimode coupler is optically connected to the first laser source through an optical splice with a radial offset.

4. The optical device of claim 3, wherein:
the radial offset is approximately 10 μm.

5. The optical device of claim 3, wherein:
a first fiber that optically connects the first laser source to the optical splice has a length that is the same as a length of a second fiber that optically connects the optical splice to the multimode coupler.

6. The optical device of claim 5, wherein:
the length is at least approximately 39 inches.

7. The optical device of claim 1, further comprising:
a low back-reflection termination optically connected to the multimode coupler.

8. The optical device of claim 7, wherein:
the low back-reflection termination is one of an angled cleave and an angled physical contact ferrule.

9. The optical device of claim 8, wherein:
the angle is equal or greater than eight degrees.

10. The optical device of claim 1, wherein:
the multimode coupler is a 2×2, 50:50 split ratio coupler.

11. The optical device of claim 10, wherein:
the multimode coupler is an 850/1300 nm coupler.

12. The optical device of claim 1, wherein:
the singlemode coupler is a 1×2, 50:50 split ratio coupler.

13. The optical device of claim 12, wherein:
the singlemode coupler is a 1270 nm to 1650 nm wideband coupler.

14. The optical device of claim 1, wherein:
the photodetector is an avalanche photodetector.

15. The optical device of claim 7, wherein:
a first fiber that optically connects the multimode coupler to the first test port has a length that is the same as a length of a second fiber that optically connects the multimode coupler to the low back-reflection termination.

16. The optical device of claim 15, wherein:
the length is at least approximately 39 inches.

17. The optical device of claim 1, wherein:
the multimode/singlemode combiner is a 1×2 combiner.

18. The optical device of claim 1, wherein:
the multimode/singlemode combiner has a loss that is less than 2 dB.

19. The optical device of claim 1, wherein:
the multimode/singlemode combiner has a loss that is approximately 1 dB or less.

20. The optical device of claim 1, wherein:
the optical device is an optical time domain reflectometer.

21. An optical device comprising:
a multimode laser source;
a 2×2, 50:50 split ratio multimode coupler optically connected to the multimode laser source;
a multimode test port optically connected to the multimode coupler;
a singlemode laser source;
a 1×2, 50:50 split ratio singlemode coupler optically connected to the singlemode laser source;
a singlemode test port optically connected to the singlemode coupler;
a photodetector; and
a multimode/singlemode combiner optically connected to the multimode coupler, singlemode coupler and photodetector.

22. The optical device of claim 21, wherein:
the multimode coupler is an 850/1300 nm coupler and the singlemode coupler is a 1270 nm to 1650 nm wideband coupler.

23. The optical device of claim 21, wherein:
the multimode coupler is optically connected to the first laser source through an optical splice with a radial offset.

24. The optical device of claim 23, wherein:
the radial offset is approximately 10 μm.

25. The optical device of claim 23, wherein:
a first fiber that optically connects the first laser source to the optical splice has a length that is the same as a length of a second fiber that optically connects the optical splice to the multimode coupler.

26. The optical device of claim 25, wherein:
the length is at least approximately 39 inches.

27. The optical device of claim 21, further comprising:
a low back-reflection termination optically connected to the multimode coupler.

28. The optical device of claim 27, wherein:
the low back-reflection termination is one of an angled cleave and an angled physical contact ferrule.

29. The optical device of claim 28, wherein:
the angle is equal or greater than eight degrees.

30. The optical device of claim 21, wherein:
the optical device is an optical time domain reflectometer.
